(19) United States
(12) Patent Application Publication
(10) Pub. No.: US 2007/0170227 A1
(43) Pub. Date: Jul. 26, 2007

(54) Soldering method

(76) Inventors: Yasuhide Ohno, Kumamoto-Ken (JP); Takashi Nakamori, Tokyo (JP); Makoto Suenaga, Kumamoto-Ken (JP); Tatsuya Takeuchi, Hyogo-Ken (JP); Johji Kagami, Hyogo-Ken (JP); Taizo Hagihara, Hyogo-Ken (JP)

Correspondence Address: DUANE MORRIS, LLP;IP DEPARTMENT, 30 SOUTH 17TH STREET, PHILADELPHIA, PA, 19103-4196, US

(21) Appl. No.: 10/588,868

(22) PCT Filed: Feb. 16, 2005
(86) PCT No.: PCT/JP05/02324

§ 371 Date: Aug. 10, 2006

(30) Foreign Application Priority Data
Feb. 17, 2004 (JP) 2004-040237

(51) Int. Cl. A47J 36/02

(52) U.S. Cl. 228/101

(57) ABSTRACT

An object of the invention is to provide a high-quality soldering method, by reducing, to a vacuum, the pressure in a vacuum room (2) in which a workpiece (10) having solid solder placed thereon consisting solely of tin or including tin and one or more components selected from silver, lead, copper, bismuth, indium and zinc is disposed. A free-radical gas is generated to remove an oxide film on the solder, and, after that, the generation of the free-radical gas is stopped, and the temperature of the solder is raised to a temperature above the melting point of the solder to melt the solder in the non-oxidizing atmosphere.

### TECHNICAL FIELD

This invention relates to a soldering method.

### BACKGROUND

Solder bumps, which may be hemispherical lumps of solder, are sometimes soldered onto circuitry on a silicon wafer, a silicon chip or a printed circuit board in order to facilitate electrical connection of such circuitry to another. An example of a method of soldering such solder bumps is disclosed in a patent document 1.

Patent document 1: JP 2001-58259 A

The technique shown in this document can eliminate the need for using flux for soldering. According to this technique, a substrate board for which soldering is provided is disposed within a vacuum room. Bumps of solder are disposed at predetermined locations on the board. The pressure in the vacuum room is reduced to a vacuum. After that, while supplying a free-radical gas in the form of hydrogen radicals to the vacuum room, the temperature within the vacuum room is raised to the melting temperature of the solder to melt the solder, and, thereafter, the vacuum room is cooled. Like this, hydrogen radicals are supplied while the solder is in a molten state.

It has been found that when soldering is carried out using this technique, a void may not go out from the soldered solder bumps so that the bumps can inflate, or when a void goes out from the solder bumps the bumps may blow up. Such inflation is considered to be caused by the hydrogen gas trapped in the molten solder. The blowing up is caused by removal of oxide films from the molten solder by the hydrogen radicals which are continuously supplied even after the solder is heated to a temperature above its melting point to change to a liquid phase and by the going out of the voids from the solder in the liquid phase, the latter occurring simultaneously with the removal of oxide films.

An object of the present invention is to provide a soldering method enabling high-quality soldering.

### DISCLOSURE OF THE INVENTION

### Subject of the Invention

In the soldering method according to the present invention, the pressure in a vacuum room, in which a workpiece with a solid-state solder is disposed therein, is reduced to a vacuum. Then, a free-radical gas is generated in the vacuum room, with which an oxide film over the solder is removed. After that, the generation of the free-radical gas is interrupted to make the atmosphere in the vacuum room non-oxidizing, and the temperature of the solder is raised above the melting point of the solder, causing the solder to melt within the non-oxidizing atmosphere. The solder may consist solely of tin, or may include tin and one or more selected from silver, lead, copper, bismuth, indium and zinc. The free-radical gas may be hydrogen radicals, for example, but other various free-radical gases can be used.

Solder tends to have an oxide film over its surface, but, even at a temperature lower than the melting point of the solder, such oxide film over the solder can be removed by exposing the solder to a free-radical gas. Accordingly, even when the temperature of the solder is raised to a temperature above the melting point after removing the oxide film, with the supply of the free-radical gas stopped, blowing up of the solder seldom occurs because the oxide film has been removed already. Furthermore, even when the solder is molten, no free-radical gas is trapped in the solder since the supply of the free-radical gas has been stopped.

Fixing the solder to the workpiece can be done, by the use of a flux or an adhesive which leaves no residue, e.g. one whose main constituent is alcohol or organic acid. Alternatively, a recess may be formed in a substrate board, within which the solder is disposed to thereby fix the solder without using a flux or adhesive.

### BRIEF DESCRIPTION OF THE DRAWINGS

FIG. 1 schematically shows an apparatus used in the soldering method according to an embodiment of the present invention.

FIG. 2 schematically shows how the temperature and pressure in the apparatus shown in FIG. 1 change when the soldering method is carried out.

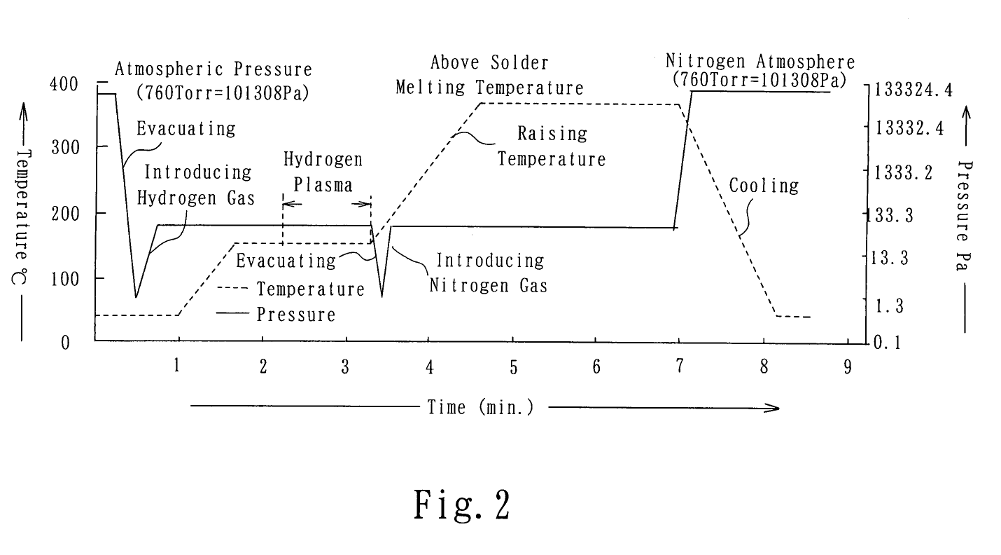

FIG. 3 is a perspective view showing how a solder ball is fixed to a workpiece in the apparatus shown in FIG. 1.

### BEST MODE FOR CARRYING OUT THE INVENTION

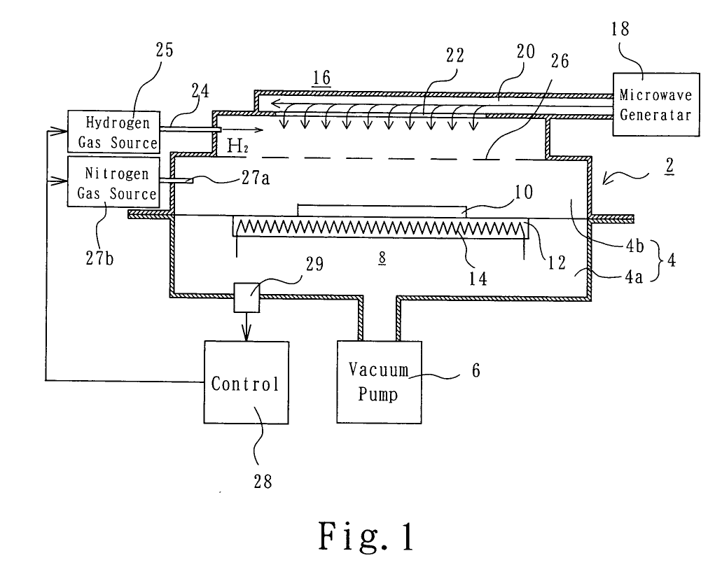

As shown in FIG. 1, a soldering apparatus used in the soldering method according to an embodiment of the present invention includes a vacuum room 2. The vacuum room 2 has a chamber 4, for example, which includes a lower chamber part 4a and an upper chamber part 4b. The lower chamber part 4a is box-shaped and has an opening on top. The upper chamber part 4b is joined to the lower chamber part 4a by means of, for example, a hinge so as to be able to close the upper opening in the lower chamber part 4a. The lower and upper chamber parts 4a and 4b are arranged such that, when the upper chamber part 4b is over the lower chamber part 4a, the interiors of both chamber parts become hermetical. Exhausting means, e.g. a vacuum pump 6, is coupled to the bottom of the lower chamber part 4a. Operation of the vacuum pump 6 with the upper chamber part 4b covering the lower chamber part 4a evacuates the interior of the vacuum room 2. The vacuum pump 6 is of a type having a controllable exhausting speed.

Within the vacuum room 2, in the lower chamber part 4a, for example, heating means, e.g. a heating device 8, is disposed. The heating device 8 has a planar support table 12. A workpiece, e.g. a silicon wafer or a printed circuit board 10 on which a solder bump is formed, is supported on a surface of the support table 12. The support table 12 is formed of a material having small thermal capacity, such as ceramic or carbon. An electric heater 14 is embedded in the support table 12. In place of the electric heater 14, an infrared heating device may be used.

A heater power supply (not shown) for the heater 14 is disposed outside the vacuum room 2, and leads to the heater 14 are led out of the vacuum room 2, while keeping the hermetical state of the vacuum room 2, and connected to the heater power supply.

A cooling device (not shown), which can be placed to contact with the entire lower surface of the support table 12, is disposed within the vacuum room 2 in such a manner as to be selectively brought into and out of contact with the lower surface of the support table 12. The cooling device is to cool the support table 12 with fluid, such as water.

When the heater 14 is being energized to heat the workpiece 10, the cooling device is out of contact with the support table 12, whereas, when the power supply to the heater 14 is interrupted, the cooling device is brought into contact with the lower surface of the support table 12 to cool the table 12. Since the support table 12 has small thermal capacity, rapid heating and rapid cooling of the support table 12 are possible.

Free-radical gas generating means, e.g. a hydrogen radical generating device 16, is disposed in the upper chamber part 4b of the chamber 4. The hydrogen radical generating device 16 makes hydrogen gas plasmatic by the use of plasma generating means, to thereby generate hydrogen radicals. The hydrogen radical generating device 16 includes a microwave generator 18 disposed outside the upper chamber part 4b. A waveguide 20 for transmitting microwaves generated in the microwave generator 18 is mounted to the upper wall of the upper chamber part 4b. The waveguide 20 has a microwave introducing window 22 therein. The microwave introducing window 22 is shaped such as to face the support table 12 and overlie the entire surface of the support table 12. Thus, the microwaves go into the upper chamber part 4b through a wide area covering the entire surface of the support table 12 as indicated by arrows in FIG. 1.

Within the upper chamber part 4b, nearby the window 22, hydrogen gas supplying means, e.g. a hydrogen gas supply tube 24 is disposed. The hydrogen gas supply tube 24 supplies hydrogen gas from a hydrogen gas source 25 disposed outside the vacuum room 2 to the interior of the upper chamber part 4b. The hydrogen gas source 25 is arranged so as to supply a controllable amount of gas into the chamber 4. The supplied hydrogen gas is changed to plasma by the microwaves introduced into the chamber 4 through the microwave introducing winding 22 to thereby generate hydrogen radicals. The hydrogen radicals are, then, led to the entire area of the workpiece 10, passing through a net 26 disposed within the upper chamber part 4b in order to capture undesired charged particles such as ions. It should be noted that a plurality of such hydrogen gas supply tubes 24 can be used. Nitrogen gas supplying means, e.g. a nitrogen gas supply tube 27a, is also disposed in the upper chamber part 4b. The nitrogen gas supply tube 27a is used to supply nitrogen gas from a nitrogen gas source 27b disposed outside the vacuum room 4 into the upper chamber part 4b. The nitrogen gas source 27b is arranged so as to supply a controllable amount of nitrogen gas into the chamber 4.

A control apparatus 28 is used to control the hydrogen gas source 25, the nitrogen gas source 27b and the vacuum pump 6. A pressure gauge 29 is provided on the chamber 4 for use in the control provided by the control apparatus 28.

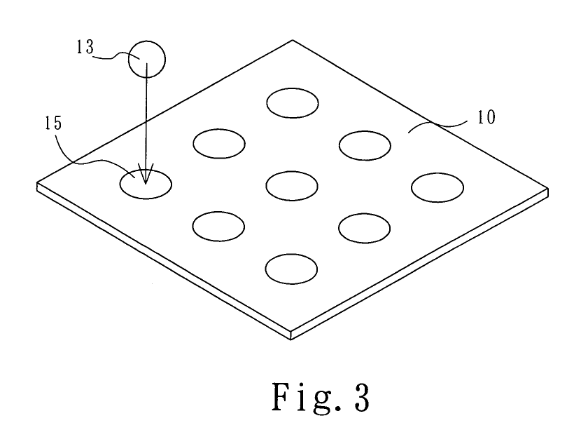

A soldering method according to one embodiment of the invention using this soldering apparatus can be carried out in the following manner shown by way of example. First, the upper chamber part 4b is opened, and a pre-formed silicon wafer or printed circuit board is disposed, as the workpiece 10, on the support table 12. A plurality of solder layers or solder balls, which are to become solder bumps, are arranged on the workpiece 10, being spaced from each other. The solder is in solid-state and consists solely of tin, or includes tin and one or more components selected from silver, lead, copper, bismuth, indium and zinc. The solder layers or solder balls are disposed directly on the workpiece 10. For example, when solder balls are used, recesses 15 are formed in the upper surface of the workpiece 10, as shown in FIG. 3, and the solder balls 13 are disposed in the recesses 15 to thereby fix the solder balls 13 in position.

After that, the upper chamber part 4b is closed, and the vacuum pump 6 is operated to evacuate the chamber 4 to, for example, about 0.01 Torr (i.e. about 1.33 Pa) to reduce the pressure in the chamber 4 to a vacuum. Next, hydrogen gas is supplied to the chamber 4. Then, the pressure within the chamber 4 becomes from about 0.1 Torr to about 1 Torr (i.e. from about 13.3 Pa to about 133.3 Pa), for example.

When the pressure in the chamber 4 becomes this pressure, the heater 14 is energized to heat the workpiece 10 to a temperature of, e.g. about 150° C., which is lower than the melting point of the solder, and this temperature is maintained. In this temperature condition, the microwave generator 18 is operated to generate hydrogen radicals in the chamber 4. The generation of the hydrogen radicals is continued for, about one (1) minute, whereby the hydrogen radicals reduce and remove oxide films associated with the solder, at the temperature lower than the melting point.

After that, the operation of the microwave generator 18 is stopped to thereby interrupt the generation of hydrogen radicals, and the vacuum pump 6 is operated to reduce the pressure in the chamber 4 to about 0.01 Torr (i.e. about 1.33 Pa). Thereafter, nitrogen gas is supplied from the nitrogen gas source 27a into the chamber 4, whereby the pressure within the chamber 4 is returned to a pressure of from about 0.1 Torr to about 1 Torr (i.e. from about 13.3 Pa to about 133.3 Pa). Then, the amount of power supplied to the heater 14 is increased to raise the temperature of the workpiece 10 above the melting point of the solder, whereby the solder on the workpiece melts. Thereafter, the power to the heater 14 is stopped, and the cooling device is brought into contact with the support table 12 to cool the workpiece 10. The cooling is also carried out rapidly so that the workpiece 10 is cooled to room temperature in, for example, one (1) minute. It should be noted that, simultaneously with the beginning of the cooling, the amount of nitrogen supplied is adjusted to bring the pressure to atmospheric pressure. The control of the vacuum pump 6, the hydrogen gas source 25 and the nitrogen gas source 27b is done by the control apparatus 28 in response to a pressure signal supplied from the pressure gauge 29 provided in the chamber 4.

Because highly reductive free-radical gas, such as hydrogen radical, is supplied over to the workpiece 10, solder oxide can be reduced without need for using flux. Furthermore, since the hydrogen radicals are supplied over to the workpiece 10 in a condition of temperature lower than the melting point of the solder, oxide films can be removed before the solder melts. Further, since the solder is melted and cooled after the oxide films are removed in a non-oxidizing atmosphere with nitrogen gas introduced into the chamber 4, it never happens that the hydrogen gas is trapped in the molten solder. Even if a void is formed in the solder, it never happens that the bumps are blown off, being triggered by the removal of oxide films since such oxide films have been removed before.

As an example, solder balls (exhibiting a melting point of 183° C.) having a diameter of 400 microns consisting of 63% of Sn and 37% of Pb, and solder balls (exhibiting a melting point of 220° C.) having a diameter of 400 microns including 96% of Sn, 3.0% of Ag and 0.5% of Cu were experimented. The solder balls were treated, with a free-radical gas being supplied for 60 seconds in temperature conditions of room temperature, 50° C., 100° C., and 150° C., which temperatures are all lower than the melting point of the solder, and, thereafter, the solder balls were heated to 225° C., which is higher than the melting point of the solder. The resulting solder bumps were investigated with scanning electron microscopy and by X-ray transmission, and it was found that no voids were formed in any of the solder balls experimented. As for the shear strength of the thus produced bumps, that of the solder consisting of 63% of Sn and 37% of Sb was in a range of from 3.2 N to 4.8 N, and that of the solder including 96% of Sn, 3.0% of Ag and 0.5% of Cu was in a range of from 3 N to 5.5 N, both of which provided satisfactory bonding strength.

In the above-described embodiment, the fixation of solder to a workpiece is done by placing solder in recesses formed in the workpiece, but solder may be fixed by the use of a flux or adhesive leaving no residual, e.g. a flux or adhesive of which major constituent is alcohol or organic acid.

In the above-described embodiment, solder bumps are formed on a workpiece, but it may be arranged in the following manner. By the use of the soldering method according to the above-described embodiment, solder bumps are formed on electrode pads on a silicon wafer or a printed circuit board. Electrodes on another silicon wafer or printed circuit board are brought into contact with the thus formed solder bumps. After that, the chamber 4 is evacuated. After a free-radical gas is generated at a temperature above the melting point of the solder, the solder is melted and, then, cooled, whereby two silicon wafers or two printed circuit boards are soldered together. In this soldering process, no flux or adhesive is used. Alternatively, it may be arranged that, after the pressure of the chamber 4 is reduced to a vacuum, the free-radical gas is generated at a temperature below the melting point of the solder, and, thereafter, the solder is melted.

Also, the following arrangement is possible. Two silicon wafers or printed circuit boards with solder bumps formed thereon by the soldering method according to the above-described embodiment are provided. The silicon wafers or printed circuit boards are placed in the chamber 4 with corresponding solder bumps contacted. Then, the pressure in the chamber 4 is reduced to a vacuum, and a free-radical gas is generated at a temperature above the melting point of the solder. Then, the solder contacting with each other melts. The solder is then cooled for soldering. Alternatively, it may be arranged that, after the pressure of the chamber 4 is reduced to a vacuum, the free-radical gas is generated at a temperature below the melting point of the solder, and, thereafter, the solder is melted.

Furthermore, the following arrangement is also possible. A silicon wafer or printed circuit board with solder bumps formed on electrode pads thereon by the soldering method according to the above-described embodiment, and a silicon wafer or printed circuit board with solder plating layers formed on electrode pads by the soldering method according to the above-described embodiment, are prepared. The silicon wafers or printed circuit boards are placed in the chamber 4 with the solder bumps brought into contact with associated ones of the solder plating layers. Then, the pressure within the chamber 4 is reduced to a vacuum, and a free-radical gas is generated at a temperature above the melting point of the solder, and the contacting solder is caused to melt. Then, the solder is cooled for soldering. Alternatively, it may be arranged that, after the pressure of the chamber 4 is reduced to a vacuum, the free-radical gas is generated at a temperature below the melting point of the solder, and, thereafter, the solder is melted.

The following is also feasible. A silicon wafer or printed circuit board having electrode pads on which solder bumps are formed by the above-described soldering method is prepared. Also, a silicon wafer or printed circuit board having electrode pads over which solder paste is applied is prepared. The wafers or boards are placed in the chamber 4 with the solder bumps on the electrode pads and the solder paste on the corresponding electrode pads being in contact. The pressure in the chamber 4 is reduced to a vacuum, and a free-radical gas is generated at a temperature above the melting point of the solder so that the solder pumps and the solder paste in contact with them are melted. After that, they are cooled to solder them together. Alternatively, it may be arranged that, after the pressure of the chamber 4 is reduced to a vacuum, the free-radical gas is generated at a temperature below the melting point of the solder, and, then, the solder is melted.

The solder useable in the present invention is not limited to the described one consisting of 63% of Sn and 37% of Pb, or the one including 96% of Sn, 3.0% of Ag and 0.5% of Cu, but solders having different composition, for example, solder consisting solely of tin, and solders including tin and one or more members selected from silver, lead, copper, bismuth, indium and zinc, can be used. Further, not only solder balls but also solder for solder-plating can be used only if the solder is solid. Further, the chamber 4 of the soldering apparatus can be modified to have an inlet port through which a workpiece can be sent into the chamber 4, an outlet port through which a workpiece can be sent out, and a semi-vacuum portion disposed between the inlet and outlet ports. With this arrangement, workpieces can be processed successively.

What is claimed is:

1. A soldering method comprising the steps of: reducing the pressure of a vacuum room with a workpiece placed therein to a vacuum, said workpiece having solder thereon in the solid state consisting solely of tin or including tin and one or more components selected from silver, lead, copper, bismuth, indium and zinc;
thereafter, generating a free-radical gas in said vacuum room to remove an oxide film on said solder; and
stopping the generation of said free-radical gas to said vacuum room to make the atmosphere in said vacuum room non-oxidizing, and raising the temperature of said solder to a temperature above the melting point of said solder to thereby cause said solder to melt.

2. The soldering method according to claim 1, wherein said solder is fixed to said workpiece, the fixing being done by forming a recess in said workpiece and placing said solder in said recess.

3. The soldering method according to claim 1, wherein said solder is fixed to said workpiece, the fixing being done by the use of a flux or adhesive comprising alcohol or organic acid as a major component thereof.
